(19) United States
(12) Patent Application Publication
(10) Pub. No.: US 2025/0368548 A1
(43) Pub. Date: Dec. 4, 2025

(54) DESALINATION WITH POLYMER HYDRATE FORMATION

(71) Applicant: UNIVERSITY OF PITTSBURGH - OF THE COMMONWEALTH SYSTEM OF HIGHER EDUCATION, PITTSBURGH, PA (US)

(72) Inventors: Sachin Shankar Velankar, Pittsburgh, PA (US); Michael Alan Gresh-Sill, St. Paul, MN (US); Ryan James MacElroy, Princeton, NJ (US); Sudesna Banerjee, Princeton, NJ (US); Tara Y. Meyer, Pittsburgh, PA (US)

(73) Assignee: UNIVERSITY OF PITTSBURGH - OF THE COMMONWEALTH SYSTEM OF HIGHER EDUCATION, PITTSBURGH, PA (US)

(21) Appl. No.: 19/224,069

(22) Filed: May 30, 2025

Related U.S. Application Data
(60) Provisional application No. 63/653,566, filed on May 30, 2024.

(51) Int. Cl. C02F 1/22; C02F 1/26

(52) U.S. Cl. CPC C02F 1/22; C02F 1/265

(57) ABSTRACT

The inventive concept includes systems and methods for desalination of saline water with polymer hydrate formation utilizing polyoxacyclobutane (POCB) to recover fresh water for human consumption and other uses, or for precipitating dissolved solutes from saline water. The inventive concept generally includes combining the POCB and a salt solution, forming a crystal hydrate mixture, and separating the crystal hydrates. The crystal hydrates are heated to form two liquid layers including a water-rich layer and a polymer-rich layer. The water-rich layer is extracted to form a water solution having a lower salt content than the initial saline water.

### CROSS REFERENCE TO RELATED PATENT APPLICATIONS

This patent application is a United States non-provisional patent application of, and claims priority to, U.S. Provisional Patent Application 63/653,566, filed on May 30, 2024, entitled “DESALINATION WITH POLYMER HYDRATE FORMATION”, which is incorporated in its entirety herein by reference.

### GOVERNMENT SUPPORT AND FUNDING

This invention was made with government support under 1933037 awarded by the National Science Foundation. The government has certain rights in the invention.

### FIELD OF THE INVENTION

The inventive concept includes systems and methods for desalination with polymer hydrate formation utilizing polyoxacyclobutane (POCB), to recover fresh water for various uses, including human consumption, as well as agriculture and industrial uses.

### BACKGROUND

Desalination is a process that takes away mineral components from saline water. In general, desalination involves the removal of salts and minerals from a target substance. Best known is the removal of salt from seawater to obtain drinking water suitable for human consumption. Most of the modern interest in desalination is focused on cost-effective provision of fresh water for human use. Existing desalination technology requires a substantial amount of energy, and the process is expensive. In addition, the amount of greenhouse gas emissions and brine wastewater generated by desalination plants may pose significant environmental challenges.

Known desalination processes utilize a variety of molecules such as propane, cyclopentane, hydrochlorofluorocarbon R141b, or t-butylammonium bromide (TBAB) that can form clathrate hydrate crystals when mixed with water, often at high pressure and low temperature. The clathrates can be separated and then melted by heating or depressuring to recover water, a process known as the HyDesal process. This approach has been examined since about 1950, including with support from the Bureau of Reclamation (BoR) and the Department of Energy, and research of this approach continues in the United States. The BoR has previously funded two pilot plants for testing desalination processes, however, no pilot plants have been funded in the United States since 2000. The current candidate processes for desalination require pressurization and/or cooling to form hydrates or have high water solubility making it difficult to recover pure water upon melting the crystals, or are flammable, or have high global warming potential.

Other known desalination processes include membrane processes, such as reverse osmosis (RO). In this process, water containing dissolved salt molecules is forced through a semi-permeable membrane (essentially a filter) under high pressure. In RO, salt water is forced against the membranes under high pressure; fresh water passes through while the concentrated mineral salts do not get through the membrane and remain behind. RO is an effective means to desalinate saline water, but it is an energy-intensive process. RO has an energy consumption of ˜3.5 kWh/m³ of fresh water; a minimum of ˜1 kWh/m³ is imposed by the thermodynamic requirements of overcoming the ˜22 bar osmotic pressure of sea water. This energy is used to operate pumps for pressurizing sea water and hence must be supplied in the form of electricity—often a challenge in less-developed countries.

Evaporation of water from salt-water solution, and then recondensing the vapor, is another approach to desalination. A version of such distillation-based desalination is membrane distillation. A hot, saltwater stream is allowed to evaporate on one side of a hydrophobic membrane, and the vapor is condensed into a cold stream on the other side of the membrane. This technology has been under development for over two decades but has not yet experienced large-scale adoption due to various technical hurdles, and economic viability remains contentious.

Apart from water for human consumption or agriculture, another fast-emerging application area for desalination technologies is the treatment of high salinity wastewaters from the unconventional oil and gas industry (shale gas). The unconventional shale gas industry produces large quantities of high salinity wastewater (>100,000 mg/L) where conventional RO treatment is not technically and economically feasible. In the United States, many such production sites are far from the ocean and hence the produced water must be pumped back underground. Thus, there is interest in technologies that reduce the volume of brine that must be pumped underground.

In summary, the demand for desalination of saline water and the corresponding electricity consumption are expected to grow sharply. The cost of desalination is currently expensive compared to most alternative sources of water, and only a very small fraction of total human use is satisfied by desalination. Generally, it is only economically practical for high-valued uses, such as household and industrial uses, in arid areas. However, there is growth in desalination for agricultural use and highly populated areas. Currently, it may be more economical to transport fresh water from somewhere else than to desalinate it. In places far from the sea, transport costs could match desalination costs. Thus, there is a need in the art to design, develop and implement desalination systems and methods that use not electricity, but waste heat, which could dramatically transform the cost and corresponding usage of desalination systems and processes to produce fresh water.

### SUMMARY OF THE INVENTION

In one aspect, the inventive concept provides a method for desalination with polymer hydrate formation. The method includes combining polyoxacyclobutane (POCB) and a salt solution to form a first mixture; cooling the first mixture to a lower temperature to form a second mixture comprising crystal hydrates; separating the crystal hydrates from the second mixture to form separated crystal hydrates; heating the separated crystal hydrates to a higher temperature thereby melting the separated crystal hydrates and forming two liquid layers, including a water-rich liquid layer; and a polymer rich liquid layer; and extracting the water-rich liquid layer to produce an extracted water solution, wherein the salt content of the extracted water solution is less than that of the salt solution used in forming the first mixture.

In certain embodiments, the lower temperature is adequately low such that the water does not freeze. In certain embodiments, the lower temperature is less than or equal to about room temperature, or lower than the freezing temperature of the crystal hydrates. Still in other embodiments, the lower temperature is from about 5° C. to about 25° C., or from about 25° C. to about 45° C., or about 5° C. to about 45° C.

In certain embodiments, the higher temperature is from about 36° C. to about 100° C., or from about 65° C. to about 100° C., or from about 36° C. to about 65° C.

In certain embodiments, the POCB has an average molecular weight of about 650 or about 2700 g/mol. Further, in certain embodiments, the POCB has an average molecular weight of about 300 g/mol or greater, or from about 300 to about 1000 g/mol, or from about 300 to about 10000 g/mol, or from about 1000 to about 10000 g/mol, or greater than about 10000 g/mol, or from about 10000 to about 500,000 g/mol.

In certain embodiments, the POCB is crosslinked or linear or branched.

In certain embodiments, the salt precipitates during the step of forming the crystal hydrates.

In certain embodiments, the salt solution includes a salt loading from zero loading to less than salt saturation. Further, in certain embodiments, the salt solution includes a salt loading from 0 to about 1.5 wt. %, or from about 1.5 wt. % to about 4.0 wt. %, or from about 26 wt. % to about 30 wt. %, or from about 4.0 wt. % to full saturation. In certain embodiments, the salt solution is a brine.

In certain embodiments, the salt solution includes a salt loading of about 3.5% by weight salt. Further, in certain embodiments, the extracted water solution comprises less than about 3.5% by weight salt.

In certain embodiments, the extracted water solution is appropriate for human use and consumption, agriculture use, and industrial use.

### BRIEF DESCRIPTION OF THE DRAWINGS

FIG. 1A is a schematic that illustrates phase diagrams applicable for POCB-water mixtures (in the absence of salt) of nominal molecular weights of 650 g/mol or nominal molecular weights exceeding 650 g/mol, in accordance with certain embodiments of the inventive concept.

FIG. 1B illustrates the phase diagram for POCB-water mixtures (in the absence of salt) of nominal molecular weight 650 g/mol, wherein the phase diagram is based on experimental data, in accordance with certain embodiments of the invention.

FIG. 1B includes solid circles representative of cloud points (i.e. temperatures at which single-phase liquid mixture transitions to a two-phase liquid mixture, and hence turns from a clear mixture to a cloudy mixture), an upper horizontal dashed line at 65° C. representing a tie line between polymer-rich and water-rich liquid phases (an upper tie line); open circles denoting the melting point of hydrate co-crystals at a temperature of 37° C., a lower horizontal dashed line at 25° C. representing a tie line between co-crystal and water-rich liquid phase (a lower tie line) and joins the crystal hydrate (23.6% water, as indicated by the thick vertical line) with the water-rich liquid phase, and a dashed curve denoting a metastable portion of the liquid-liquid equilibrium (LLE) curve, in accordance with certain embodiments of the inventive concept. FIG. 1A is a schematic that applies to a molecular weight of 650 g/mol, as well as other molecular weights. It shows the same features as FIG. 1B, but numeric data points are omitted since the melting temperature of the hydrate and the location of the LLE curve may change as the POCB molecular weight changes. Due to the changes in melting temperature of the hydrate and the location of the LLE curve, the temperature suitable for the upper and lower tie lines may also be different from that in FIG. 1B.

FIG. 2 is a schematic that illustrates a process for water desalination wherein the recited temperatures of 25° C. and 65° C. correspond to the lower and upper tie lines in FIG. 1B, one temperature is above the melting point of the hydrate and the other temperature is below the melting point of the hydrate, wherein the two temperatures are for illustration purposes only and therefore may vary, in accordance with certain embodiments of the inventive concept.

FIG. 3 is a plot that illustrates an effect of the molecular weight of the POCB on the solubility of water into the water-rich phase at a temperature of 40° C., wherein the arrows labeled “POCB650” and “POCB2700” correspond to the polymers used in Parts A and C, respectively, in the Examples section herein, in accordance with certain embodiments of the inventive concept.

FIGS. 4A and 4B are plots that illustrate the effect of sodium chloride salt on the phase transition temperatures of mixtures of POCB of nominal molecular weight 650 g/mol and water, in accordance with certain embodiments of the inventive concept. FIG. 4A shows that when salt is added to a POCB+water mixture with 18 wt. % water, the cloud point (i.e., the temperature at which the mixture transitions from two-phase LLE to homogeneous single-phase liquid or vice versa) reduces. FIG. 4B shows that when salt is added to a POCB+water mixture with 30 wt. % water, the melting point of the POCB hydrate reduces. It is noted that the amounts of salt needed for reducing cloud point in FIG. 4A are much lower than the amounts of salt needed for reducing hydrate melting temperature in FIG. 4B.

### DETAILED DESCRIPTION OF THE INVENTION

The inventive concept includes systems and methods for desalination of saline water with polymer hydrate formation, wherein the polymer is polyoxacyclobutane (POCB), and recovery of fresh water.

In addition, the inventive concept includes methods for desalination utilizing a purely thermal approach and a benign chemical (e.g., POCB polymer), without requiring the use of cooling for hydrate formation or high pressure for crystal formation. Without intending to be bound by any particular theory, based on the observation that most crystals reject impurities during crystallization, the inventive concept reasons that when POCB is added to salt water, it will sequester pure water (or water with a lower salt content as compared to the salt content of the original salt water to which the POCB is added) during crystallization. Separating and then melting these crystals, in a liquid-liquid equilibrium (LLE) region, will release most of the water having a lower salt content (as compared to the salt content of the original salt water to which the POCB is added). Thus, the separation and subsequent extraction step results in predominantly POCB polymer along with a small amount, e.g., negligible amount, of water such that a large amount of (e.g., nearly pure) water can be recovered for various uses including, but not limited to, human consumption, as well as agriculture and industrial uses.

Unlike reverse osmosis (RO) which requires large amounts of electricity, the process of the inventive concept can be operated using heat-even waste heat, at low temperature. Unlike RO or membrane distillation, the inventive concept does not involve membranes and hence is not susceptible to fouling. Unlike desalination based on gas hydrates, the inventive concept does not require high pressure or low temperature. POCB hydrate formation is remarkably tolerant of salt and proceeds even with fully saturated salt solutions. Accordingly, the inventive concept can be used to purify high-salinity water. Thus, the inventive concept has the potential for thermal desalination across a wide range of salinities. Further, the inventive concept successfully provides for desalination of brine ranging from dilute (1% water) to concentrated (salt-saturated water).

The mixture of water and POCB, having a relatively large molecular weight, e.g., at least several hundred g/mol, displays the following two interesting characteristics:
(i) At high temperature, the mixture separates into two liquid phases: a polymer-rich phase, coexisting with nearly pure water; and
(ii) At low temperature, the mixture forms hydrate crystals of polymer and water.

Thus, according to the inventive concept, a polymer-rich phase and a coexisting nearly pure water phase are formed when the mixture of water and POCB is subjected to a temperature that is sufficiently high to form these two liquid phases. Further, according to the inventive concept, hydrate crystals of polymer and water are formed when the mixture of water and POCB is subjected to a temperature that is sufficiently low to form these two phases.

The phenomenon of co-crystallization is rare in organic systems. This unusual phase-behavior offers a convenient approach to water desalination.

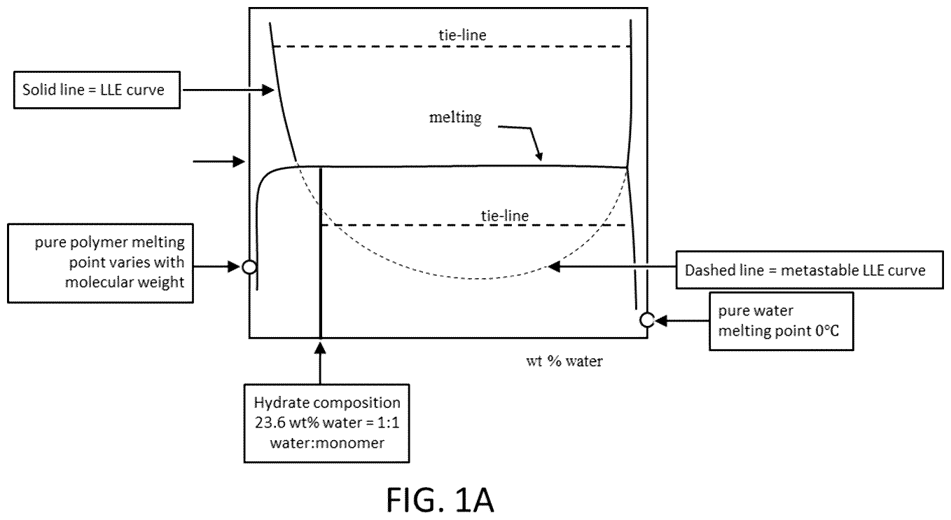

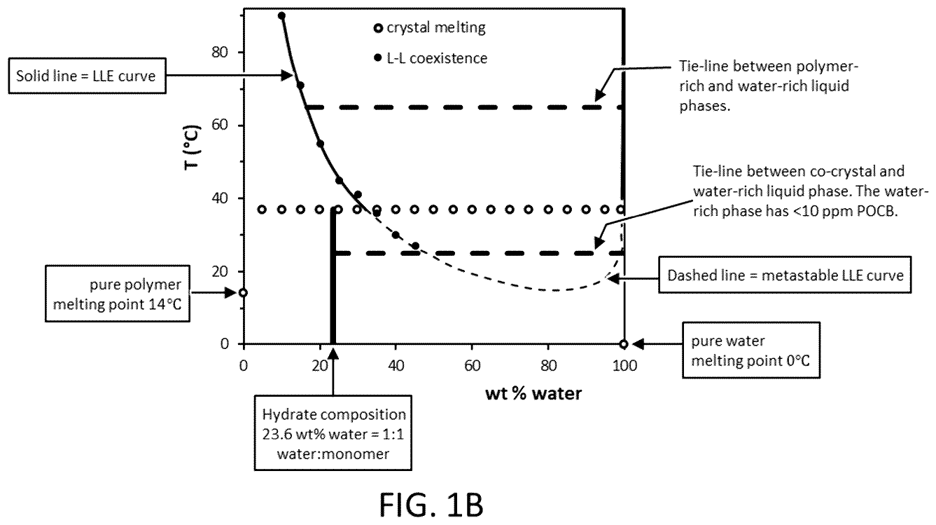

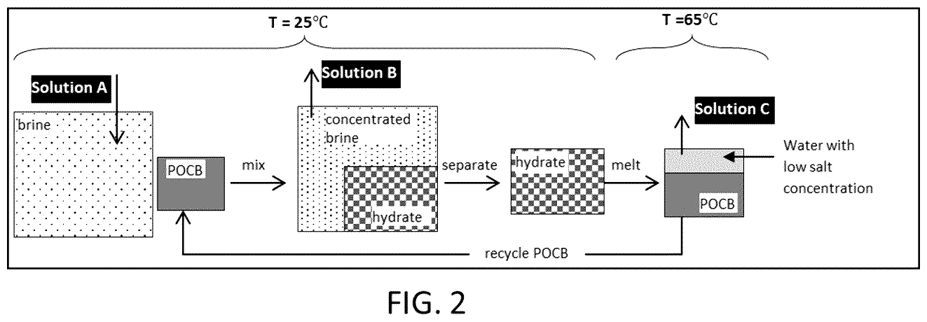

FIG. 1A shows a schematic of the phase diagram of mixtures of water and POCB where the POCB molecular weight is sufficiently high to be useful for the inventive concept. In certain embodiments, in order to be useful for the inventive concept, the POCB has low solubility in water, a hydrate melting temperature that is above room temperature, and the temperature for LLE is relatively low, e.g., below 100 C. In addition, POCB molecular weights below 300 g/mol do not meet these requirements and are not useful in the inventive concept. FIG. 1B shows a phase diagram of mixtures of water and POCB where the POCB has a molecular weight of 650 g/mol. These phase diagrams are representative of a “union” of two features. The first feature is liquid-liquid equilibrium (LLE). The mixtures are single-phase at low temperature (e.g., absent of heating), but separate into a polymer-rich and a water-rich liquid phase upon heating. The second feature is co-crystallization wherein the polymer and water form a crystal hydrate (with approximately 23.6% water) which melts at a temperature higher than either of the pure components. The hydrate has a 1:1 molar ratio of water to the repeat unit (CH₂CH₂CH₂O). In mass-terms, the crystal is 23.6% water. In the art, such co-crystallization is unusual in polymeric systems. Co-crystallization with water is even less common. Thus, the combination of the features of crystallization and LLE is unique, and it would be unexpected that POCB co-crystallizes with a small molecule with which it is immiscible under molten conditions.

FIG. 1A is a general schematic of the LLE and co-crystallization features. FIG. 1B illustrates results experimentally obtained in accordance with the inventive concept. In FIG. 1B, the solid-filled circles are experimental cloud points (which denote the boundary of the LLE region); the upper dashed line (at 65° C. in FIG. 1B) exemplifies a tie line between polymer-rich and water-rich liquid phases; the open circle(s) denote the melting point of hydrate co-crystals (at 37° C. in FIG. 1B); the lower dashed line (at 25° C. in FIG. 1B) exemplifies a tie line between co-crystal and water-rich liquid phase, joining the crystal hydrate composition (23.6 wt. % water in FIG. 1B, a thick vertical line at one end of the tie line) with the water-rich liquid phase; the solid and dashed line portions of the curve denote a metastable portion of the LLE curve.

Furthermore, as illustrated in FIG. 1B, the horizontal dashed line at about 65° C. is identified as the “Tie-line between polymer-rich and water-rich liquid phases;” the horizontal dashed line at about 25° C. is identified as the “Tie-line between co-crystal and water-rich liquid phase;” the open circles are identified as “crystal melting;” the solid circles are identified as “L-L coexistence;” the solid vertical line at the end of the “Tie-line between co-crystal and water-rich liquid phase” is identified as “23.6 wt. % water=1:1 water: monomer”.

In mass-terms, the crystal is 23.6 wt. % water; such co-crystallization is unusual in polymeric systems. Co-crystallization with water is even less common. Accordingly, the combination of crystallization and LLE is unique; and it is unexpected that a polymer, e.g., POCB, would co-crystallize with a small molecule with which it is immiscible under molten conditions.

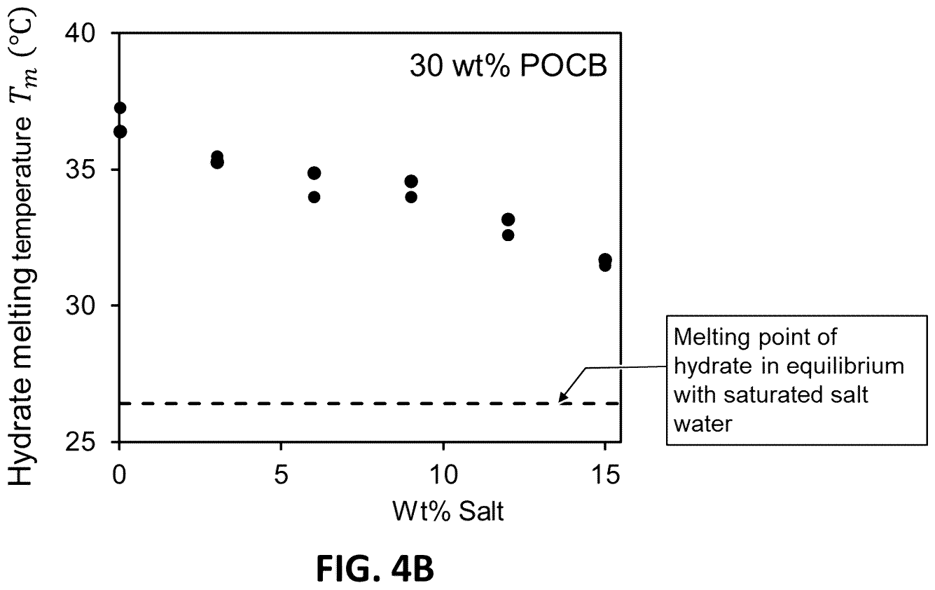

Further, with respect to FIGS. 4A and 4B, there was also measured the phase behavior with NaCl showing that the diagram remains qualitatively similar, but the cloud point reduces (or equivalently, the LLE region expands) and the melting point of the hydrate reduces. Specifically, mixtures of POCB, water, and salt transition from being in two-phase LLE at relatively high temperatures to homogeneous single-phase liquid at lrelatively lower temperatures. This transition is called the cloud point, which also corresponds to the boundary of the LLE region. The cloud point at a variety of mixture compositions, but in the absence of salt, is shown by the filled circles in FIG. 1B. FIG. 4A shows the effects of added salt for mixtures containing 18 wt. % water. The temperature at which the LLE-to-homogeneous transition occurs during cooling is shown by the open circles in FIG. 4A. The temperature at which the homogeneous-to-LLE transition occurs during heating is shown by the filled circles in FIG. 4A. The fact that these heating vs cooling transition temperatures are close to each other suggests that thermodynamic equilibrium is maintained. FIG. 4A shows that relatively small amounts of salt (less than 0.1 wt. %) lower the cloud point temperature significantly.

Salt also affects the temperature at which the hydrate melts. The hydrate melting temperature at a variety of mixture compositions, but in the absence of salt, is shown by the open circles in FIG. 1B. FIG. 4B shows the effects of added salt for mixtures containing 30 wt. % POCB. FIG. 4B shows that the melting temperature of the hydrate decreases significantly when several weight percent of salt are added. When equilibrated with fully saturated salt water, the hydrate melting temperature reaches 26.4° C., a value that is indicated by the horizontal dashed line in FIG. 4B. At this melting point, four phases are in equilibrium solid salt, solid hydrate, salt-saturated water with negligible amounts of dissolved POCB, and a liquid phase which contains POCB, some water, and very little salt.

Note that the experiments of FIG. 4 were conducted with a single POCB molecular weight of 650 g/mol, but similar results are expected with other molecular weights. Note that the compositions of 18% water in FIG. 4A and 30% POCB in FIG. 4B were chosen as examples. Mixtures with other fractions of water or POCB are expected to behave similarly.

Further, above the hydrate melting point, the salt is almost entirely in the aqueous phase.

Most crystals tend to exclude impurities; thus, it is plausible that if polymer is added to salty water at low temperature (corresponding to the lower tie line in FIGS. 1A and 1B), the crystal hydrate will sequester a certain amount of water (23.6 wt. % in the ideal case) while rejecting the salt. This crystal hydrate is then separated from the salty water and melted (corresponding to the upper tie line in FIGS. 1A and 1B) to obtain two liquid phases, one of which is nearly pure water. The polymer-rich liquid phase is then recycled to sequester more (nearly pure) water. In certain embodiments, the amount of water that dissolves into the POCB polymer is about 27% by weight of the solution when the POCB polymer has an average molecular weight of 650 g/mol, and about 5% by weight of the solution when the POCB polymer has an average molecular weight of 2700 g/mol.

In certain embodiments, the POCB polymer has an average molecular weight of about 650 or about 2700 g/mol or within a range of about 650 to about 2700 g/mol. In other embodiments, the POCB polymer has an average molecular weight of about 300 g/mol or greater, or from about 300 to about 1000 g/mol, or from about 300 to about 10000 g/mol, or from about 1000 to about 10000 g/mol, or greater than about 10000 g/mol, or from about 10000 to about 500,000 g/mol. In certain embodiments, the POCB polymer is crosslinked or linear or branched. Furthermore, high molecular weight polymers may exhibit increased viscosity.

In certain embodiments, the original saltwater and the saltwater left behind after hydrate crystallization can include a salt-saturated water solution.

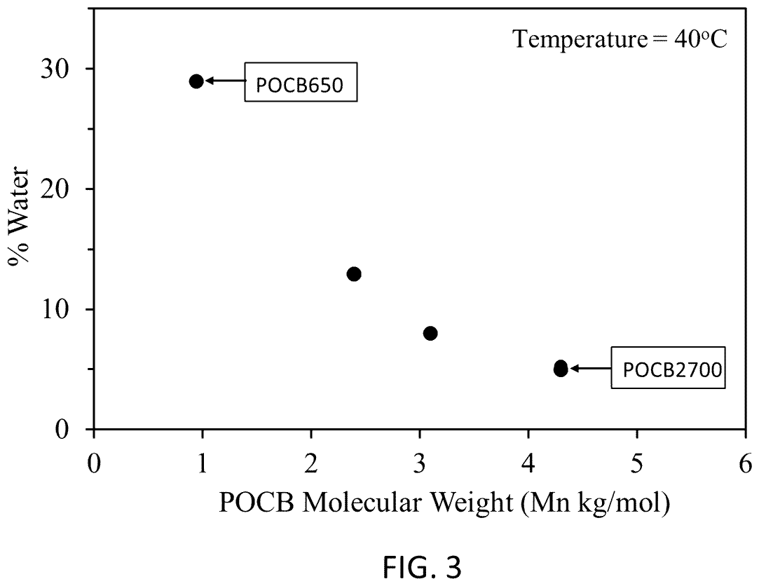

FIG. 2 is a schematic that illustrates a process for water desalination according to the inventive concept, wherein the two temperatures of 25° C. and 65° C., respectively, correspond to the upper and lower tic lines in FIGS. 1A and 1B. FIG. 2 is based on principles that are substantially different from RO. The osmotic pressure of the sea water is overcome not by mechanical pressure (associated with RO), but by the free energy change of the hydrate crystallization process. Electricity use is minimal, e.g., for pumping or mixing.

In FIG. 2, includes a salt solution (Solution A), designated as “brine”, which is mixed with polymer, designated as “POCB”. The brine/POCB mixture is cooled to a temperature of about 25° C. At this temperature, the mixture crystallizes to form concentrated brine (Solution B) and crystal hydrate (containing POCB and water). The concentrated brine is separated from the crystal hydrate. In certain embodiments, a portion of salt solution (referred to as “hold-up liquid) may be trapped between the particulate crystals of the hydrate. The crystal hydrate (including hold-up liquid) is heated to a temperature that is adequate to melt the hydrate, and to form two separate liquid layers: an upper layer containing fresh water (Solution C) and a lower layer containing POCB). The upper layer (water-rich layer) is a less dense phase which has low viscosity, as compared to the lower layer (polymer-rich layer) that is denser and has higher viscosity. The (fresh) water layer (Solution C) has a lower salt content than the starting solution (Solution A).

Moreover, due to relatively low temperature needed to melt the hydrate and obtain a two-phase liquid mixture, only a modest or a low temperature is needed to recover water from the crystals, and hence even waste heat or solar thermal energy could be used for melting the hydrate. The temperature can vary. In general, the temperature can be as low as desired provided that the water does not freeze at the low temperature. In certain embodiments, the temperature is less than or equal to about room temperature, or the temperature is lower than the freezing temperature of the hydrate (ranging from about 36° C. to about 45° C.), or the temperature is from about 5° C. to about 25° C., or from about 25° C. to about 45° C., or about 5° C. to about 45° C.

A high or higher temperature is used to separate the POCB polymer and water into the two liquid phases: a polymer-rich phase, coexisting with nearly pure water. The temperature can vary. In certain embodiments, the temperature is about 100° C. or lower, or higher than the melting temperature of the hydrate (ranging from about 36° C. to about 45° C.), or from about 36° C. to about 100° C., or about 65° C., or from about 65° C. to about 100° C., or from about 36° C. to about 65° C.

The approach disclosed herein is a variation of desalination processes based on clathrate hydrates of small molecules, but with two crucial advantages unique to POCB as listed below.
1. POCB is a benign polymer that forms a hydrate at room temperature and atmospheric pressure; and
2. Upon melting the hydrate, the liquid polymer is almost completely insoluble in water.

Accordingly, neither a vacuum nor pressure is needed. The process in FIG. 2 involves only mixing, sedimentation, and modest heating-all of which require only simple and inexpensive equipment. As an added benefit, unlike RO or membrane distillation, the process in FIG. 2 is not susceptible to membrane fouling, and therefore the process is much more tolerant of high salinity. Indeed, the hydrate can form even when POCB is equilibrated with saturated salt (NaCl) water (as described and demonstrated in Part D of the Examples section below). In general, the salt solution can have a salt loading within a range from zero loading to salt saturation or from zero loading to less than salt saturation. In certain embodiments, the salt loading is from 0 to about 1.5%, or from about 1.5% to about 4.0%, or from about 4% to about 26%, or from about 4.0% to full saturation, based on total weight of the salt solution (e.g., brine).

### EXAMPLES

The experiments in Sections A and B were conducted using POCB originally sold by DuPont under the name Cerenol. The manufacturer-quoted molecular weight was 650 g/mol (the GPC measurements as conducted indicated Mn and Mw values of 942 and 1490 g/mol, respectively). It was prepared by condensation polymerization of 1,3-propanediol and had hydroxyl terminal groups. It was liquid at room temperature with a melting temperature of 14° C. This polymer is referred to as POCB650 henceforth. The phase behavior of POCB650 corresponded to FIGS. 1A and 1B.

The data of FIG. 1B were measured as follows. For cloud point determination (i.e., measuring the filled circle data). POCB-water mixtures (roughly 3 g total) were placed in glass vials and immersed in a water bath whose temperature was maintained by a temperature controlled hot plate. The actual water temperature was measured by a thermometer immersed in the bath. Temperatures were gradually raised until the onset of cloudiness and then lowered again to verify that the cloudiness disappeared. The same procedure was used for measuring cloud points for salt-containing samples (FIG. 4A). For determining the melting points of the hydrate (open circle data), the same vials were allowed to crystallize at room temperature. In some cases, stirring was necessary to ensure that the mixtures did not separate into layers. At low water content, crystallization at room temperature was slow, and hence vials were cooled to roughly 1-4° C. to accelerate crystallization. Crystallized samples were then immersed in a water bath and heated until melting. A minimum of 5 min equilibration time was imposed at each temperature during heating. To verify that the crystallization temperature did not affect melting temperature, a limited number of samples were allowed to crystallize at 36° C. These yielded the same melting temperature as those crystallized at room temperature. The same procedures was used for measuring melting points of salt-containing samples (FIG. 4B).

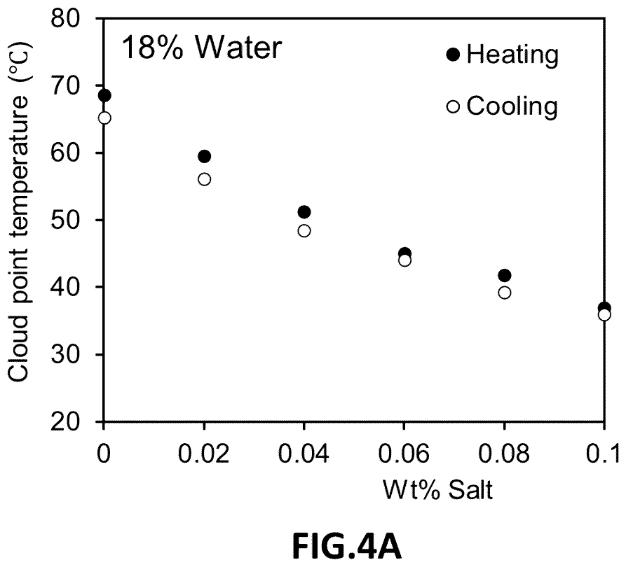

For the data of FIG. 3, which are referred to at a single temperature of 48° C., roughly 2 mL of samples of various polymer: water ratios were placed in vials, first melted at above 48° C., and then placed in a water bath at 40° C. After temperature equilibration, the vials were shaken. Cloudy samples were deemed to be in LLE, whereas transparent ones were deemed to be single-phase. Each cloud point composition reported in FIG. 3 is midway between the lowest water content that appeared cloudy and the highest water content that appeared transparent.

Note, subsequent experiments discovered that roughly 30 wt. % of POCB650 (corresponding to the lowest molecular weight fractions) was soluble in water under salt-free conditions. Salt greatly expands the LLE region and hence under the conditions of the experiment below, the amount of polymer dissolved in the aqueous phase is likely much lower.

### Part A. Experimental Procedure

A 3.5 wt. % salt solution in water was prepared and denoted SS (for Starting Solution). SS (20 g) was mixed with POCB650 (4 g) in a conical flask and heated to 60° C., a temperature at which it formed two liquid phases. This initial heating was only to ensure a consistent, fully molten starting state. It was not a critical part of the desalination process.

The mixture was cooled to 30° C. by immersing the flask in a water bath. A stir bar was used to ensure that the polymer-water mixture remained well-mixed. After 21 hours at 30° C., the mixture had crystallized. Crystallization proceeded nearly to completion under these conditions. (Subsequent experiments showed that this crystallization time is reduced by orders of magnitude by lowering the temperature by several degrees.)

Upon centrifugation of the above, the supernatant (denoted SN) was removed, leaving behind the solid centrifugate. A small amount of supernatant remained trapped between the particulate crystals; this liquid (which is identical to SN) was indicated as “holdup liquid”. The crystals along with the holdup liquid were melted at 60° C. resulting in two liquid layers. The upper, less dense phase, which had low viscosity, was denoted WR (Water Rich). The lower denser phase, which had high viscosity, was dubbed PR (Polymer Rich). A small portion of WR was extracted from the top of the centrifuge tube. Below we will show that WR has a lower salt content than SS.

### Part B. Quantification of Salt Content

### Quantification by Evaporation

Small amounts of SS, SN, WR, and the centrifugate were weighed into aluminum pans and then allowed to evaporate at 200° C. From the weight loss, the weight of the evaporation residue was calculated, and the following results were obtained.

| | |
|---|---|
| SS | 3.6 wt. % residue (expected to be salt only); |
| SN | 3.73 wt. % residue (expected to be salt and possibly a small |
| | amount of polymer that remained dissolved or suspended |
| | after completion of crystallization and centrifugation); |
| WR | 2.2 wt. % residue (expected to be salt and possibly a small |
| | amount of polymer that partitions into the WR phase at |
| | 60° C.); and |
| Centrifugate | 50.6% liquid residue (expected to be polymer and a small |
| | amount of salt left behind from the holdup liquid). |

### Quantification by Ion Chromatography

Some of the salt solutions were too concentrated to be measured directly by ion chromatography and hence, all of this quantification was performed by dilution experiments. Ten standard salt solutions were prepared by diluting SS to 3, 6, 9, 12, 18, 20.6, 24.3, 32, 36 and 40 parts per million. The areas under the chromatography curves were obtained by integration and then used to measure salt solution concentrations.

All the test solutions were diluted in known amounts of water. The concentrations of these diluted solutions were obtained by chromatography, and then the concentrations of S and WR were back calculated. These concentrations were as follows.

| | |
|---|---|
| SS | 3.7 wt. % |
| SN | 3.68 wt. % |
| WR | 1.81 wt. % |

Both evaporation as well as ion chromatography suggested that WR was depleted in salt as compared to SS. Thus, these results indicated that at least some amount of desalination could be performed by the schematic illustrated in FIG. 2. Yet, it was recognized that at least a part of the salt in WR came from the holdup liquid. Above the evaporation residue from the centrifugate was listed as 50.6% implying that 49.6% is water. A majority of the water was from the holdup liquid (a minority was the water of crystallization in the hydrate crystals). Clearly the holdup liquid contained salt (since it had the same composition as SN). Removal of this holdup liquid without melting the crystals could result in an even greater degree of salt removal.

Part C: Batch Desalination with High Molecular Weight POCB

Subsequently, a second set of experiments was conducted with higher molecular weight material. This was motivated by two reasons. First, it was found that the LLE region expanded (or equivalently the cloud point reduced) with increasing molecular weight. For example, FIG. 3 shows the solubility of water in the POCB-rich phase with increasing molecular weight (MW). Thus, with lower solubility, there was expected a higher degree of water recovery upon melting the hydrate (referring to FIGS. 1A and 1B, the left end of the tie line at high temperature would move further to the left, thus allowing more water to be recovered). Second, after the set of experiments in Part A herein, it was realized that the material used in this previous section had roughly 30% POCB of sufficiently low molecular weight fraction to be soluble in water under salt-free conditions. As shown in FIG. 4A, salt greatly expanded the LLE region even at extremely low loadings (below 0.1 wt. %) and hence it was unlikely that there would be sufficient solubility to affect the results. In contrast, POCB of higher MW was found to have negligible (less than 0.1 wt. %) solubility in water, thus removing this potential complication.

These experiments were therefore conducted with Velvetol 2700 (supplied by WeylChem) which is also made by condensation polymerization of 1,3-propanediol. The manufacturer-quoted MW is 2700 g/mol, and GPC measurements that were taken indicated Mn and Mw values of 4295 and 8568 g/mol respectively. This material is referred to as POCB2700 henceforth.

### Experimental Procedure

A 1 wt. % salt solution in water was prepared and denoted SS (for Starting Solution). SS (482.9 g) was mixed with POCB2700 (99.1 g) in a food-grade blender (Ninja Pro) at 40° C., a temperature at which it forms two liquid phases. This initial heating was only to ensure a consistent, fully molten, starting state. It was not a critical part of the desalination process.

The mixture was then blended, for 60 min, in 30 s of blending, followed by 300 s of rest time. This was because the mixing process itself produced heat, whereas hydrate crystallization requires cooling, thus continuous blending was undesirable. At the end of this process, the contents of the blender consisted of a slurry of solid hydrate particles suspended in salt water. This was then centrifuged in 50 mL centrifuge tubes. The hydrate “cake” was recovered from the centrifuge tubes and sandwiched between filter papers for several minutes to remove excess water. Approximately 120 g of hydrate was recovered from the filter papers and transferred into tall cylindrical vials and allowed to melt at 45° C. for 5 hours. The entire tube was immersed in a water bath during this process to ensure homogeneous temperature throughout. At the end of this process, approximately 20 mL of clear aqueous phase was found to be floating atop a cloudy layer of polymer-rich phase. The salt content of this aqueous phase was determined by solution conductivity measurements and found to be 0.22 wt. %. Thus, the desalination reduced the salt content by 78% as compared to the original brine.

In a second iteration of this experiment, the same process was repeated, with the following quantities. SS (309 g) was mixed with POCB2700 (51.5 g). The total hydrate recovered was 64.3 g. The final water recovered was roughly 15 mL with a salt concentration of 0.25 wt %. Thus, the desalination reduced the salt content by 75% as compared to the original brine.

### Part D: Batch Desalination With High Molecular Weight POCB and Salt-Saturated Brine

This experiment followed Part C and had a different motivation. FIG. 4B shows that salt reduces the melting temperature of the hydrate, but even with 15 wt. % salt, the melting point is well above room temperature. Other experiments found that the hydrate is remarkably tolerant of salt and can even form from salt-saturated water, raising the possibility of desalination of high-salinity water. Thus, the experiment of this section sought to test whether the desalination could be conducted at far higher salt contents. In fact, an inability to tolerate high salinity water is a well-known limitation of reverse osmosis or membrane distillation.

Saturated brine (SB) was prepared by adding excess salt to water, allowing the excess salt to settle, and decanting the supernatant saturated brine.

SB (342 g) was mixed with POCB2700 (86 g) in a food-grade blender (Ninja Pro) at 40°° C., a temperature at which it forms two liquid phases. This initial heating was only to ensure a consistent, fully molten, starting state. It was not a critical part of the desalination process. The blending procedure was similar to that in Part C with 30 s mixing alternating with 300 s rest time. One difference was that during each rest period, the mixer vessel was placed in a cold-water bath set to 14° C. This was because, when in equilibrium with salt-saturated brine, the melting point of the hydrate is significantly lowered, roughly to 26° C. Thus, hydrate crystallization at room temperature (which was readily viable in Section C) was unacceptably slow in the presence of saturated brine. Accordingly, a lower temperature was needed to achieve hydrate crystallization within one hour. Incidentally, since hydrate removes water from the saturated water, salt precipitation was expected and indeed salt crystals were found to be deposited on the walls of the vessel. One difference as compared to Part C was that the hydrate was less dense than the saturated saltwater and hence floated at the top of the blender. Salt crystals were denser than the brine and hence were expected to sink (although in this case, they were found stuck to the walls of the blender).

After hydrate formation, the hydrate was removed from the blender. Following the same procedure in Part C, it was centrifuged, and excess brine was removed from the hydrate by filter paper. The total hydrate recovered was 66.4 g. Upon heating to 42° C., approximately 15 mL of water was recovered. This water was denser than POCB indicating a relatively high salt content (in fact, the density of brine exceeded that of POCB at approximately 2.5 wt. % salt). Conductivity measurements indicated a salt concentration of 9.5 wt. %. Saturated salt brine at room temperature had 26 wt. % salt, and hence the final recovered water had a salt concentration that was 64% lower than the original brine.

We claim:

1. A method for desalination with polymer hydrate formation, comprising:
combining polyoxacyclobutane and a salt solution to form a first mixture;
cooling the first mixture to a lower temperature to form a second mixture comprising crystal hydrates;
separating the crystal hydrates from the second mixture to form separated crystal hydrates;
heating the separated crystal hydrates to a higher temperature thereby melting the separated crystal hydrates and forming two liquid layers, comprising:
a water-rich liquid layer; and
a polymer rich liquid layer; and
extracting the water-rich liquid layer to produce an extracted water solution,
wherein the salt content of the extracted water solution is less than that of the salt solution used in forming the first mixture.

2. The method of claim 1, wherein the lower temperature is adequately low such that the water does not freeze.

3. The method of claim 1, wherein the lower temperature is less than or equal to about room temperature.

4. The method of claim 1, wherein the lower temperature is lower than the freezing temperature of the crystal hydrate.

5. The method of claim 1, wherein the lower temperature is from about 5° C. to about 45° C.

6. The method of claim 1, wherein the lower temperature is from about 5° C. to about 25° C., or about 25° C. to about 45° C.

7. The method of claim 1, wherein the higher temperature is higher than the melting temperature of the separated crystal hydrates.

8. The method of claim 1, wherein the higher temperature is from about 36° C. about 100° C.

9. The method of claim 1, wherein the higher temperature is from about 65° C. to about 100° C. or about 36° C. to about 65° C.

10. The method of claim 1, wherein the polyoxacyclobutane has an average molecular weight of about 650 or about 2700 g/mol.

11. The method of claim 1, wherein the polyoxacyclobutane has an average molecular weight of about 300 g/mol or greater, or from about 300 to about 1000 g/mol, or from about 300 to about 10000 g/mol, or from about 1000 to about 10000 g/mol, or greater than about 10000 g/mol, or from about 10000 to about 500,000 g/mol.

12. The method of claim 1, wherein the polyoxacyclobutane is crosslinked or linear or branched.

13. The method of claim 1, wherein salt precipitates during the step of forming the crystal hydrates.

14. The method of claim 1, wherein the salt solution to form the first mixture comprises a salt loading from zero loading to less than salt saturation.

15. The method of claim 1, wherein the salt solution to form the first mixture comprises a salt loading from 0 to about 1.5 weight %, or from about 1.5 weight % to about 4.0 weight %, or from about 26 weight % to about 30 weight %, or from about 4.0 weight % to full saturation.

16. The method of claim 1, wherein the salt solution to form the first mixture is a brine.

17. The method of claim 1, wherein the salt solution to form the first mixture comprises a salt loading of about 3.5% by weight salt.

18. The method of claim 1, wherein the extracted water solution comprises less than about 3.5% by weight salt

19. The method of claim 1, wherein the extracted water solution comprises from about 3.5wt. % to about 10 wt. % by weight salt.
